(19) United States
(12) Patent Application Publication
(10) Pub. No.: US 2016/0018598 A1
(43) Pub. Date: Jan. 21, 2016

(54) Collimating And Concentrating Light Into An Optical Fiber

(71) Applicant: OFS FITEL, LLC, Norcross, GA (US)

(72) Inventor: Jan I Hansson, West Hartford, CT (US)

(21) Appl. No.: 14/774,327

(22) PCT Filed: Mar. 13, 2013
(86) PCT No.: PCT/US13/31090

§ 371 Date: Sep. 10, 2015

(51) Int. Cl. G02B 6/26; F21S 11/00; G02B 19/00; G02B 6/32; G02B 3/08

(52) U.S. Cl. CPC G02B 6/262; G02B 6/264; G02B 6/32; G02B 3/08; G02B 19/0028; G02B 19/0042; F21S 11/002

(57) ABSTRACT

The present disclosure provides an optical design configured to achieve an increased concentration and improved coupling of light to an optical fiber for a passive lighting system. Light may be passed through a collector lens followed by collimation and concentration to yield improved coupling of light to an optical fiber. Additionally, the optical design reduces the total number of optical fibers required to achieve effective illumination.

### BACKGROUND

1. Technical Field

The present disclosure relates generally to passive lighting and, more specifically, to concentrating light in passive lighting systems utilizing optical fibers.

2. Description of the Related Art

Optical fibers play important roles in many applications including long-distance telecommunication, industrial lasers, and more recently passive lighting. The collection and transmission of solar light through optical fibers offer a robust, economical, and environmentally-friendly alternative to conventional artificial lighting techniques. Thus, there are ongoing developments to improve such lighting systems.

### SUMMARY

The present disclosure provides an optical design configured to achieve an increased concentration and improved coupling of light to an optical fiber for a passive lighting system. In some embodiments, light is passed through a collector lens followed by collimation and concentration to yield improved coupling of light to an optical fiber.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram showing the effect of the numerical aperture (NA) on the ability to propagate solar light rays along the optical fiber.

FIG. 2A is a diagram showing an inefficient coupling of diffuse light directly to an optical fiber.

FIG. 2B is a diagram showing an inefficient coupling of solar light directly to an optical fiber.

FIGS. 3A and 3B are diagrams showing inefficient coupling of focused solar light to an optical fiber.

FIG. 4 is a diagram showing collection and concentration of solar light.

FIG. 5 is a diagram showing collection and coupling of solar light to an optical fiber by collimating and narrowing the light path, in accordance with an aspect of the present invention.

### DETAILED DESCRIPTION OF THE EMBODIMENTS

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

Passive lighting is a sustainable, architectural design element that offers a robust, economical, and environmentally-friendly alternative to current artificial lighting solutions. A primitive example of passive lighting is the use of glass doors, windows, and skylights to illuminate a building interior or space with solar light. However, not all spaces within a building are well suited for these basic passive lighting solutions. For example, an interior room with no access to an exterior wall or roof cannot be passively illuminated by the addition of a window or skylight. One solution to this is to use optical fibers as conduits in passive lighting systems.

Optical fibers play a vital role in a variety of fields such as long distance telecommunications and industrial lasers. More recently, optical fibers have been used to provide safety lighting, background lighting, and medical lighting. Optical fibers, in theory, are desirable conduits for use in passive lighting systems because optical fibers provide transmission of light with very little attenuation.

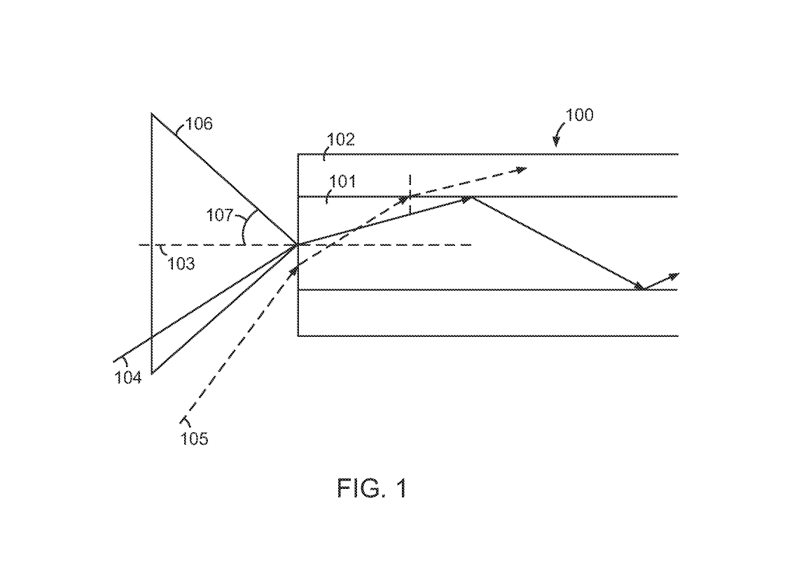

The low attenuation of light through an optical fiber occurs because of the structure of the optical fiber, as shown in FIG. 1. The optical fiber 100 comprises a core 101 surrounded by a cladding 102. The core 101 of the optical fiber 100 serves as a waveguide for light because it has an index of refraction (n₁) that is greater than the index of refraction of the cladding 102 (n₂). Not all light rays are propagated along the optical fiber 100 (FIG. 1). Which light rays are propagated along any single optical fiber is dependent upon a numerical aperture (NA) of the fiber. The NA is related to indices of refraction of the core 101 and cladding 102 and is equal to ((n₁)²−(n₂)²)^{1/2}. The NA defines a range of acceptance angles rotated around a longitudinal axis 103 of the optical fiber 100, where light can be coupled into the core 101 of the optical fiber 100. A sum of all the acceptance angles forms what is known in the art as an acceptance cone 106. A critical angle 107 is equal to the arc-sine of the NA and is the angle beyond which light cannot be coupled into the core 101 of the optical fiber 100. Therefore, light 104 that enters the core 101 of the optical fiber at an angle within the acceptance cone 106, and thus less than or equal to the critical angle 107, will be coupled into the core 101 of the optical fiber 100 and propagated. In contrast, light 105 that enters the core of the fiber at an angle outside the acceptance cone 106, and thus greater than the critical angle 107, will not be coupled into the core 101 of the fiber 100 and is lost in the cladding 102.

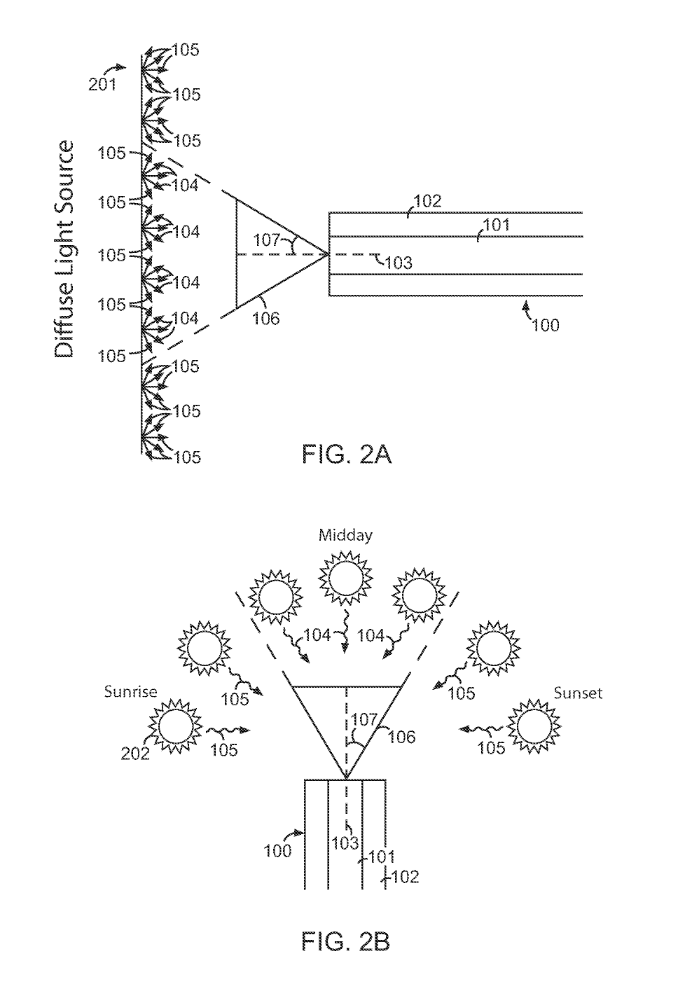

Diffuse light 201 emits light rays at all possible angles (±90°), as shown in FIG. 2A. This makes direct coupling of a diffuse light source to optical fibers inefficient for passive lighting. While some light rays 104 are within the NA of the fiber core, many of the light rays 105 enter the core 101 of the optical fiber beyond the critical angle 107. Those light rays that enter the core beyond the critical angle 107 are not coupled within the core 101, resulting in poor light intensity in the optical fiber 100. Thus, direct coupling of diffuse light to the optical fiber is not a suitable technique for passive lighting. The same problem occurs when using a light source that is partially diffuse (emits light into a range of angles narrower than ±90°).

Although collimated, solar light suffers the same fate as diffuse or partially diffuse light as the sun 202 moves across the sky during the day, as shown in FIG. 2B. As one can see, the movement of the sun across the sky results in more rays being incident on the optical fiber 100 at angles that are outside of the acceptance cone 106. For example, at sunrise and sunset, light rays 105 are well beyond the critical angle 107 of the core 101 of the optical fiber 100, and will not be propagated through the core 101. However, as the sun 202 moves higher in the sky, the light rays 104 enter the core 101 of the optical fiber 100 at angles within the acceptance cone 106 and are propagated through the core 101. In short, without a mechanism in place to allow the core 101 of the optical fiber 100 to face the sun 202 throughout the day, coupling of sunlight directly into an optical fiber 100 only occurs during a small window of time during the day. Therefore, the use of optical fibers as conduits in passive lighting systems typically requires tracking of the sun, and diffuse lighting does not work well even with tracking in place. In sum, optical fibers, standing alone, do not gather sufficient light if exposed to the sun.

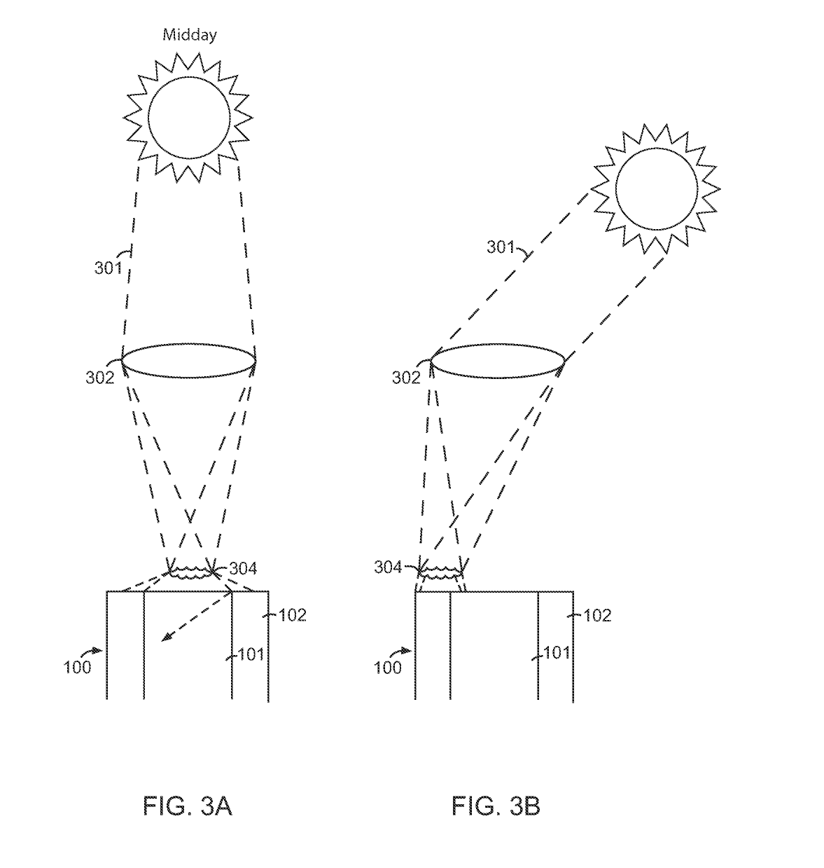

For cost effective systems, sunlight must be concentrated before entering the fiber. For example, sunlight 301 can be focused onto an end-face of an optical fiber using a convex lens, a minor, or a Fresnel lens 302, as shown in FIGS. 3A and 3B. FIG. 3A shows coupling of focused sunlight into an optical fiber. At or around midday, the sun is sufficiently aligned such that sunlight 301 passes through a lens 302 and is focused 304 onto the end face of an optical fiber 100, coupled into the core 101 and propagated down the fiber 100. However, when the sun is not sufficiently aligned with the optical fiber 100 as shown in FIG. 3B, sunlight 301 is not coupled into the core 101 of the optical fiber. This is because sunlight passes through the lens 302 at such an angle that the focal point 304 becomes misaligned with the core 101 of the optical fiber 100. As such, tracking is imperative with good accuracy (e.g., better than 1 degree) because even a small difference will create a significant deviation and loss.

Furthermore, the use of imaging techniques to focus light onto the end face of an optical fiber suffers from an optical limitation, namely, the smallest light spot that can be created. The size of the focal spot thus limits the smallest optical fiber diameter that can be used for light propagation. The smallest spot 304 is essentially the image of the sun created by the lens or reflector at its focal point.

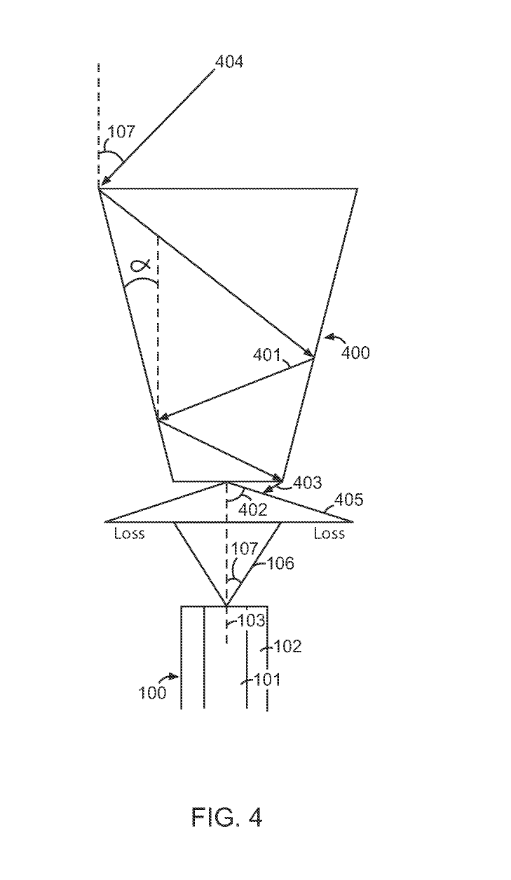

To overcome the limitations of purely imaging techniques, various non-imaging optical techniques have been employed. Non-imaging optics refers to techniques directed at achieving optimal transfer of light between a source distribution and a target distribution. Common non-imaging optical techniques seek to achieve maximal concentrations of light. In short, non-imaging optics aim at gathering light rays that are incident to an aperture of a given area and ensure that they exit through an aperture with a smaller area, thus concentrating the light rays. Thus, a wide acceptance cone 402 of a concentrator 400, such as that shown in FIG. 4, can reduce or eliminate the need for expensive techniques to allow for precise tracking of the sun. The development of non-imaging concentrators is well established for solar thermal applications.

Although the use of a concentrator may reduce or eliminate the need to precisely track the sun, it does not solve the problem of inefficient coupling of solar light to the optical fiber. As shown in FIG. 4, light within the critical angle 107 at the entrance of concentrator 400 is propagated through the concentrator 400. The tapering design alters the path 401 of the light such that the same amount of light is contained in a smaller amount of space, effectively intensifying the light. Light then exits the concentrator 400 through an opening with a greater NA than the entrance, resulting in exiting light with a wider range of angles 405 than entering light. In other words, the critical angle 402 is greater for the exiting light 403 than it is for the entering light 404. Suffice it to say that while the exiting light 403 is more intense than entering light 404, it is also more diffuse. This results in the loss of any light ray outside the acceptance cone 106 of the core 101 of the optical fiber 100.

In short, ensuring a high concentration ratio does not guarantee that all light propagates through the optical fiber. Although the light is in effect intensified, light rays exiting the concentrator fill a wider range of angles than did light rays entering the concentrator. Thus, the NA for the output side of the concentrator is much greater than the NA for the input side. In other words, the light at the exit aperture is more concentrated in intensity, but more diffuse in angular extent. Therefore, coupling of solar light rays to the core of the optical fiber remains inefficient, limiting the practicality of using fiber optics in passive lighting systems.

Additionally, the concentration factor currently attainable with the use of a concentrator alone is far less than what a typical optical fiber itself can handle. For example, in an optical fiber with a 0.5 NA, the maximum concentration factor achievable is about 4,000. However, many optical fibers can handle greater energies, up to at least a concentration factor of about 100,000. For these reasons, there still exists a need for an economically feasible and efficient solution to gather solar light and maximize coupling of the solar light to an optical fiber for transmission of this light in passive lighting systems.

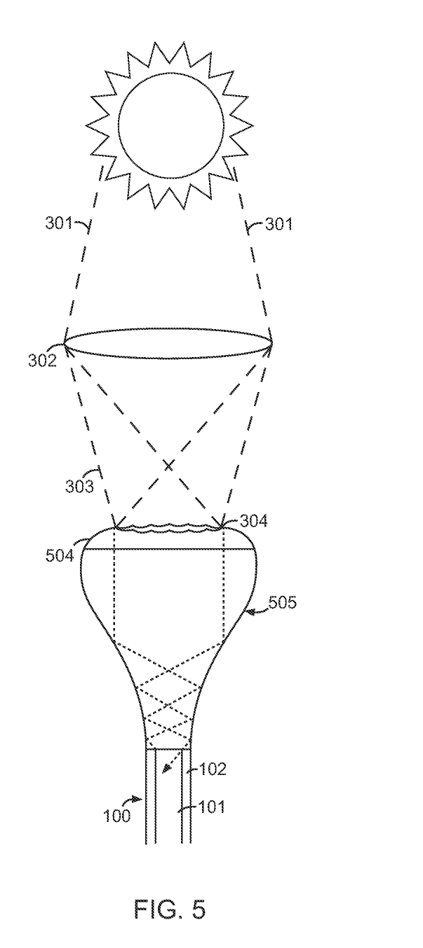

The aforementioned shortcomings can be overcome by collimating light followed by concentrating the aligned light to narrow its path, as shown in FIG. 5. In one embodiment, solar light 301 passes through a collector lens 302. The collector lens 302 focuses the image 304 of the sun. Light rays 303 are then aligned parallel to one another as they pass through a collimator 504 placed beyond a focal point of the image 304 of the sun. The light path is then narrowed as the light rays pass through a tapered conducting rod 505 that is optically coupled to the collimator 504. Light rays within the NA of the optical fiber 100 are then propagated into the core 101 of the optical fiber 100. The optical fiber 100 is optically coupled to the conducting rod 505, preferably through a well-matched optical coupling (e.g., core-matched splice) that permits most, if not all, of the light in the conducting rod 505 to be transferred to the core 101 of the optical fiber 100.

Collimation prior to concentration results in a marked increase in the concentration factor attained. The collimation reduces an actual exit angle on the output side of the tapered conducting rod such that efficient coupling to the optical fiber is achieved. Therefore there is more efficient coupling of solar light to the optical fiber. For example, a 4:1 reduction in a diameter of a light path in the aforementioned embodiment results in a 16:1 increase in the concentration factor. Thus, a fiber with a 0.5 NA, when used in this configuration, would achieve a concentration factor of 64,000 after collimation, instead of 4,000 (which is the case without collimation).

In some embodiments, the collector lens is a Fresnel lens. In other embodiments, the collector lens may be integrated into a solar collection panel. The collimator may be fused with the tapered conducting rod or it may be independent. Further, the collimator may be placed at any length from the collector lens. The tapered conducting rod may be replaced with any means for narrowing or tapering the pathway of the propagating light. In some embodiments, the tapered conducting rod may be a tapered clad rod. For some embodiments, the NA of the tapered conducting rod may be greater than 0.6. The tapered conducting rod may comprise both a core and a cladding or, in the alternative, be made without cladding. Also, the tapered conducting rod may be any shape including, but not limited to, hour glass, straight, conical, or parabolic. The optical design disclosed may also be employed to collect light from artificial sources, such as light-emitting diodes, as well as natural sources, such as the sun.

Also, attenuation of light is greater in plastic optical fibers than in glass optical fibers. Typically, plastic optical fibers have a loss of about 0.25 dB per meter, whereas glass optical fibers only have a loss of a few dB per kilometer. One reason for the attenuation is because plastic optical fibers contain more impurities, which over the length of the fiber absorb or scatter some of a light.

Although glass optical fibers are higher quality and are generally preferable, they are more expensive per unit as compared to plastic optical fibers. However, when used in the embodiments disclosed herein, the number of fibers required for any given application can be reduced because of the increased concentration factor achieved. For example, if a 4:1 reduction in light path diameter is achieved (thereby resulting in a sixteen-fold increase in concentration factor), then sixteen-fold fewer optical fibers may be used to propagate the same amount of light. Therefore, significant savings can be realized over the use of other passive lighting systems incorporating optical fibers, even though glass optical fibers are utilized.

Although exemplary embodiments have been shown and described, it will be clear to those of ordinary skill in the art that a number of changes, modifications, or alterations to the disclosure as described may be made.

What is claimed is:

1. A system comprising:
a lens to focus solar light at a focal point;
a collimator optically coupled to the lens, the collimator being located near the focal point, the collimator to align the focused solar light;
a tapered conducting rod optically coupled to the collimator, the tapered conducting rod to narrow the aligned solar light; and
an optical fiber optically coupled to the tapered conducting rod, the optical fiber to receive the narrowed solar light from the tapered conducting rod and transmit the solar light.

2. A system comprising:
a collimator, and
a tapered conducting rod optically coupled to the collimator.

3. The system of claim 2, the collimator being fused to the tapered conducting rod.

4. The system of claim 2, further comprising a collector lens, the collector lens being optically coupled to the collimator, the collector lens to receive light and focus the light at a focal point.

5. The system of claim 4, the collimator being located beyond the focal point.

6. The system of claim 4, the collector lens being a Fresnel lens.

7. The system of claim 2, further comprising an optical fiber, the optical fiber being optically coupled to the tapered conducting rod.

8. The system of claim 2, further comprising a solar collection panel, the optical fiber being located in the solar collection panel.

9. The system of claim 2, the optical fiber being a silica-based optical fiber.

10. The system of claim 2, the tapered conducting rod comprising:
a core; and
a cladding located radially peripheral to the core, the core and the cladding tapered along their length so as to form an hour glass.

11. A method, comprising:
focusing light from a light source;
aligning the focused light;
narrowing the aligned light through a means for tapering the path of the aligned light; and
propagating the narrowed light through an optical fiber.

12. The method of claim 11, the step of focusing the light comprising:
focusing the light using a Fresnel lens.

13. The method of claim 11, the step of aligning the focused light comprising:
aligning the focused light using a collimator.

14. The system of claim 13, further comprising the step of placing the collimator beyond a focal of the focused light.

15. The system of claim 11, the optical fiber being a silica-based optical fiber.

16. The system of claim 11, wherein the means for tapering is a tapered conducting rod.
